(19) United States
(12) Patent Application Publication
(10) Pub. No.: US 2012/0206666 A1
(43) Pub. Date: Aug. 16, 2012

(54) DISPLAY DEVICE USING SWITCHING PANEL AND METHOD FOR MANUFACTURING SWITCHING PANEL

(75) Inventors: Yong Cheol JEONG, Yongin-si (KR); Seung-Hoon LEE, Hwaseong-si (KR); Seung Jun JEONG, Asan-si (KR); Hae Young YUN, Suwon-si (KR); Jin Hwan KIM, Suwon-si (KR)

(73) Assignee: Samsung Electronics Co., Ltd., Suwon-si (KR)

(21) Appl. No.: 13/217,701

(22) Filed: Aug. 25, 2011

(30) Foreign Application Priority Data
Feb. 10, 2011 (KR) 10-2011-0011963

(51) Int. Cl. G02F 1/1337; B05D 3/06

(52) U.S. Cl. 349/15; 427/553

(57) ABSTRACT

An image display device includes a display panel which displays an image, and a switching panel which operates in a 2-dimensional (“2D”) mode or in a 3-dimensional (“3D”) mode, where the switching panel controls the image of the display panel to be recognized as a 2D image in the 2D mode and as a 3D image in the 3D mode, where the switching panel includes: a first and second substrates opposite to each other; a first electrode layer on the first substrate; a first alignment layer on the first electrode layer; a second electrode layer on the second substrate; and a liquid crystal layer between the first substrate and the second substrate, where the switching panel includes a unit elements, and when no voltage is applied between the first electrode layer and the second electrode layer, a pretilt angle of the liquid crystal layer is repeated in the unit elements.

This application claims priority to Korean Patent Application No. 10-2011-0011963, filed on Feb. 10, 2011, and all the benefits accruing therefrom under 35 U.S.C. §119, the content of which in its entirety is herein incorporated by reference.

### BACKGROUND OF THE INVENTION

(a) Field of the Invention

Exemplary embodiments of the present invention relate to an image display device using a switching panel and a method for manufacturing the switching panel.

(b) Description of the Related Art

In recent years, as display device technology has developed, a 3-dimensional (“3D”) stereoscopic image display device has attracted attention and various 3D image display methods have been researched.

One of methods that are most widely used in displaying the stereoscopic image is a method of using a binocular disparity. In the method of using the binocular disparity, an image that reaches a left eye and an image that reaches a right eye are displayed in the same display device, and the images are inputted into the left eye and the right eye of an observer, respectively. That is, images observed at different angles are inputted into both eyes to allow the observer to perceive a 3D effect.

In a method using a binocular disparity, the method of inputting the images into the left eye and the right eye includes a method of using a barrier and a method of using a lenticular lens, which is a kind of cylindrical lens.

The stereoscopic image display device using the barrier forms a slit on the barrier and divides the image from the display device into a left-eye image and a right-eye image through the slit to be inputted into the left eye and the right eye of the observer, respectively.

The stereoscopic image display device using the lens displays the left-eye image and the right-eye image and divides the image from the stereoscopic image display device into the left-eye image and the right-eye image by changing a light path through the lens.

While 2-dimensonal (“2D”) image display methods is changed to stereoscopic image display methods, 2D-cum-3D image displays has been developed, and switchable lenses has been developed for the 2D-cum-3D image displays.

A liquid crystal lens for controlling a refractive index distribution thereof to match a refractive index distribution of an optical lens by controlling the distribution of liquid crystal directors with the electric field may be used for the switchable lenses. However, when a cell gap of the liquid crystal lens is large, it controls the liquid crystal incompletely, and the incomplete control of the liquid crystal generates aberration on the lens to deteriorate a 3D image.

### BRIEF SUMMARY OF THE INVENTION

Exemplary embodiments of the present invention relate to an image display device with improved lens characteristics.

In an exemplary embodiment, an image display device includes a display panel which displays an image, and a switching panel which operates in at least one of a 2-dimensional (“2D”) mode and a 3-dimensional (“3D”) mode, where the switching panel controls the image of the display panel to be recognized as a 2D image in the 2D mode and as a 3D image in the 3D mode, where the switching panel includes: a first substrate; a second substrate disposed opposite to the first substrate; a first electrode layer disposed on the first substrate; a first alignment layer disposed on the first electrode layer; a second electrode layer disposed on the second substrate; and a liquid crystal layer disposed between the first substrate and the second substrate, where the switching panel includes a plurality of unit elements, and when no voltage is applied between the first electrode layer and the second electrode layer, a pretilt angle of the liquid crystal layer is repeated in the plurality of unit elements.

In an exemplary embodiment, a first unit element of the plurality of unit elements may include at least one zone, and the first alignment layer may be optically aligned such that the pretilt angle of the liquid crystal layer may decrease toward a center of the first unit element from an outer part of the at least one zone.

In an exemplary embodiment, when no voltage is applied between the first electrode layer and the second electrode layer, the switching panel may operate in the 3D mode, and when a voltage is applied between the first electrode layer and the second electrode layer, the switching panel may operate in the 2D mode.

In an exemplary embodiment, the at least one zone of the first unit elment may be provided to be symmetric with respect to the center.

In an exemplary embodiment, when the switching panel operates in the 3D mode, the pretilt angle of the liquid crystal layer corresponding to the first unit element may be substantially symmetric with respect to the center of the first unit element.

In an exemplary embodiment, when the switching panel operates in the 2D mode, the liquid crystal layer may be vertically aligned.

In an exemplary embodiment, when the switching panel operates in the 2D mode, the switching panel may have a same phase delay in each position thereon.

In an exemplary embodiment, when the switching panel operates in the 3D mode, the phase delay may increase toward the center of the first unit element from the outer part of the at least one zone.

In an exemplary embodiment, the pretilt angle of the liquid crystal layer corresponding to the first unit element may decreases toward the center of the first unit element from the outer part of the at least one zone, the pretilt angle of the liquid crystal layer at the center of the first unit element may be about zero degree, and the pretilt angle of the liquid crystal layer at the outer part of the at least one zone may be about 90 degrees.

In an exemplary embodiment, the pretilt angle of the liquid crystal layer corresponding to the first unit elment may continuously decrease toward the center of the first unit element from the outer part of the at least one zone.

In an exemplary embodiment, the pretilt angle of the liquid crystal layer corresponding to the first unit element may discontinuously decrease toward the center of the first unit element from the outer part of the at least one zone.

In an exemplary embodiment, the image display device may further include a second alignment layer disposed on the second electrode layer.

In an exemplary embodiment, the pretilt angle of the liquid crystal layer near the second alignment layer may be substantially constant.

In an exemplary embodiment, the second alignment layer may be optically aligned such that the pretilt angle of the liquid crystal layer decreases toward the center of the first unit element from the outer part of the at least one zone.

In an exemplary embodiment, the first unit element may include a plurality of zones sequentially disposed from the center thereof such that a first zone thereof is disposed closer to the center thereof than a second zone thereof, and a width of the first zone is greater than a width of the second zone.

In an exemplary embodiment, when the switching panel operates in the 3D mode, the first unit element may operates as a Fresnel zone plate.

In an alternative embodiment of the present invention, a method for manufacturing a switching panel, which includes a first substrate, a second substrate disposed opposite to the first substrate, a first electrode layer disposed on the first substrate, a second electrode layer disposed on the second substrate, and a liquid crystal layer disposed between the first substrate and the second substrate, includes: coating a photosensitive material on the first electrode layer of the first substrate; and irradiating light to the photosensitive material, where the switching panel includes a plurality of unit elements, a first unit element of the plurality of unit elements includes at least one zone sequentially disposed from a center of the first unit element, and where the irradiating of light with at least one of increased intensity and decreased intensity toward the center of the first unit element from an outer part of the at least one zone.

In an exemplary embodiment, the method may further include arranging the zone and a mask, and transmittance of the mask may decrease or increase toward the center of the first unit elment from the outer part of the at least one zone.

In an exemplary embodiment, the mask may include a plurality of subzones sequentially disposed toward the center of the first unit element from the outer part of the at least one zone, and transmittance of the plurality of subzones may decrease or increase toward the center of the first unit element from the outer part of the at least one zone.

In an exemplary embodiment, the method may further include arranging the zone and a mask, and the mask includes an opening which shifts, and a duration of light irradiation to the at least one zone may be controlled by shifting the opening.

According to the exemplary embodiments of the present invention, an image display device with improved lens characteristics may be provided.

### BRIEF DESCRIPTION OF THE DRAWINGS

The above and other aspects, advantages and features of the invention will become more apparent by describing in further detail exemplary embodiments thereof with reference to the accompanying drawings, in which:

FIGS. 1 and 2 are conceptual diagrams illustrating a schematic configuration of an exemplary embodiment of an image display device according to the present invention and methods of forming a 2-dimensional (“2D”) image and a 3-dimensional (“3D”) image, respectively;

FIG. 3 is a perspective view of an exemplary embodiment of a switching panel of an image display device according to the present invention;

FIG. 4 is a cross-sectional view taken along line IV-IV of a switching panel shown in FIG. 3;

FIG. 5 is a top plan view of the switching panel shown in FIG. 3;

FIG. 6 is a top plan view an alternative exemplary embodiment of a switching panel according to the present invention;

FIG. 7 is a graph showing a phase delay in an exemplary embodiment of a unit element according to positions therein;

FIG. 8 is a graph showing a phase delay in an alternative exemplary embodiment of a unit element according to positions therein;

FIG. 9 is a partial cross-sectional view of an exemplary embodiment of a switching panel in a 3D mode according to the present invention.

FIG. 10 is a partial cross-sectional view of an alternative exemplary embodiment of a switching panel in a 3D mode according to the present invention.

FIG. 11 is a cross-sectional view of an exemplary embodiment of a switching panel in a 2D mode according to the present invention;

FIG. 12 is a top plan view of an exemplary embodiment of a mask for photo-alignment of an alignment layer;

FIG. 13 is a top plan view of an alternative exemplary embodiment of a mask for photo-alignment of an alignment layer;

FIG. 14 is a plan view showing an arrangement of liquid crystal molecules in a liquid crystal layer of an exemplary embodiment of a switching panel in a 3D mode according to the present invention;

FIG. 15 is a graph showing a phase delay according to a position on a switching panel in a 3D; and

FIG. 16 is a graph showing an azimuth according to a position on a switching panel operable in a 3D mode.

### DETAILED DESCRIPTION OF THE INVENTION

The invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” or “under” relative to other elements or features would then be oriented “upper” or “above” relative to the other elements or features. Thus, the exemplary term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein. Hereinafter, an exemplary embodiment of a display device according to the present invention will be described in detail with reference to the accompanying drawings.

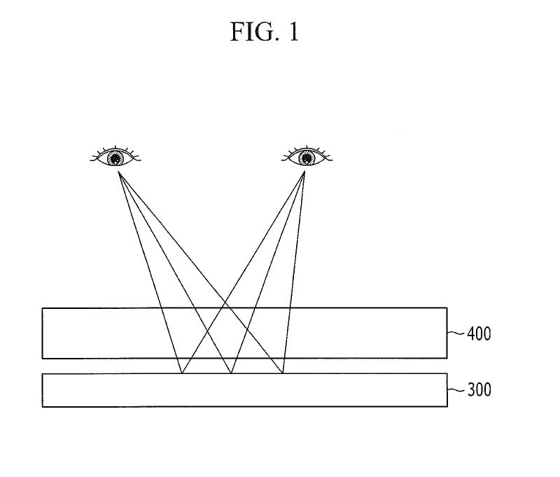

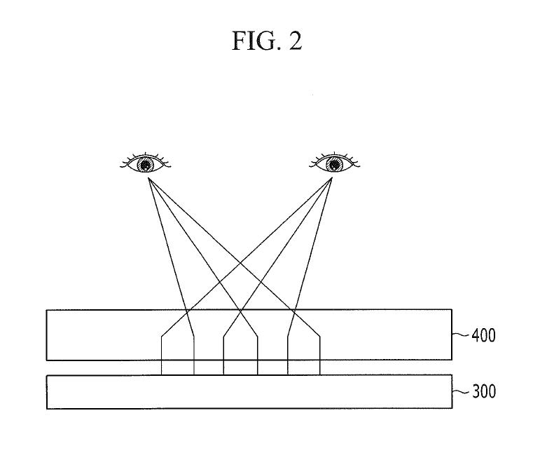

FIGS. 1 and 2 are conceptual diagrams illustrating a schematic configuration of an exemplary embodiment of an image display device according to the present invention and methods of forming a 2-dimensional (“2D”) image and a 3-dimensional (“3D”) image, respectively.

Referring to FIGS. 1 and 2, the image display device includes a display panel 300 for displaying images and a switching panel 400 disposed opposite to a surface on which the image of the display panel 300 is displayed. The display panel 300 and the switching panel 400 may operate in a 2-dimensional (“2D”) mode or a 3-dimensional (“3D”) mode.

The display panel 300 may be a flat panel type display such as a plasma display panel (“PDP”), a liquid crystal display (“LCD”), or an organic light emitting diode (“OLED”) display, for example. The display panel 300 includes a plurality of pixels PX arranged in a matrix form, and displays an image. In the 2D mode, the display panel 300 displays one 2D image. However, in the 3D mode, the display panel 300 may alternately display images corresponding to various visual fields, such as right eye images and left eye images, for example, using a space or time division method. In one exemplary embodiment, for example, the display panel 300 may alternately display right eye images and left eye images in each pixel column in the 3D mode.

The switching panel 400 transmits an image displayed on the display panel 300 as it is in the 2D mode, and divides visual fields of the mage of display panel 300 in the 3D mode. That is, the switching panel 400 operating in the 3D mode focuses multiple viewpoint images, including a left eye image and a right eye image displayed on the display panel 300, on visual fields corresponding to each viewpoint image using the diffraction and refraction phenomenon of light.

FIG. 1 shows a case where the display panel 300 and the switching panel 400 operate in the 2D mode in which an identical image reaches the left eye and the right eye such that a 2D image is perceived, and FIG. 2 shows a case where the display panel 300 and the switching panel 400 operate in the 3D mode in which the switching panel 400 divides an image of the display panel 300 into the left eye image and the right eye image by diffracting the image such that a 3D image is perceived.

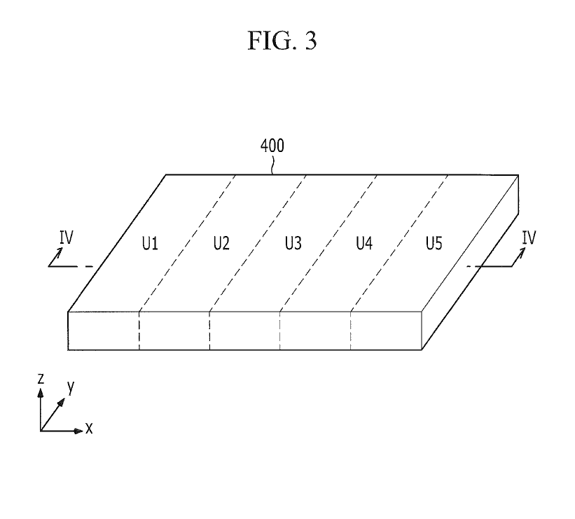

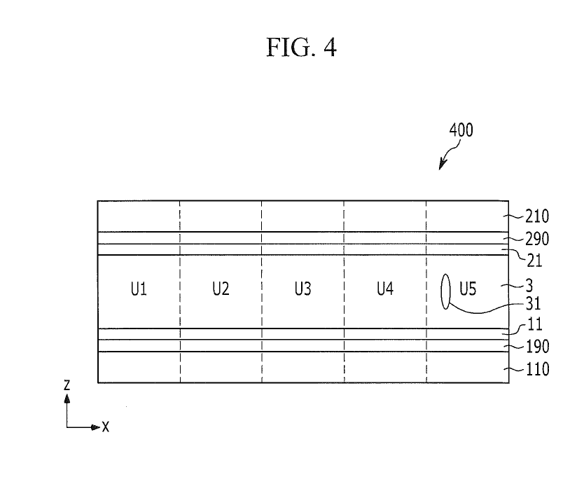

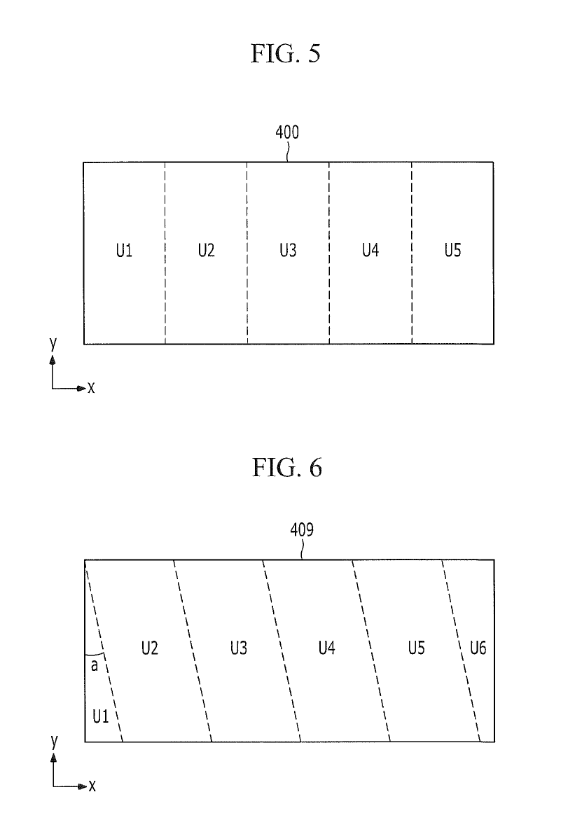

FIG. 3 is a perspective view of an exemplary embodiment of a switching panel of an image display device according to a the present invention, FIG. 4 is a cross-sectional view taken along line IV-IV of the switching panel shown in FIG. 3, and FIG. 5 is a top plan view of the switching panel shown in FIG. 3.

Referring to FIGS. 3 to 5, the switching panel 400 includes a plurality of unit elements (U1-U5) sequentially arranged along an x-axis direction. A single unit element covers a viewpoint N (N is a natural number) of the display panel 300. A single viewpoint corresponds to a single pixel (or sub-pixel). In an exemplary embodiment, for example, a unit element covers a viewpoint 9.

The switching panel 400 includes an insulating material such as glass or plastic, for example, and includes a first substrate 110 and a second substrate 210 disposed opposite to each other and a liquid crystal layer 3 provided between the first and second substrates 110 and 210. A polarizer (not shown) may be disposed at an outer part of the first and second substrates 110 and 210.

A first electrode layer 190 and a first alignment layer 11 are sequentially disposed on the first substrate 110, and a second electrode layer 290 and a second alignment layer 21 are sequentially disposed on the second substrate 210. The first electrode layer 190 and the second electrode layer 290 may include a transparent conductive material such as indium tin oxide (“ITO”) or indium zinc oxide (“IZO”), for example. Each of the first electrode layer 190 and the second electrode layer 290 may be formed as a single electrode without an additional pattern.

As shown in FIG. 5, boundaries between the unit elements (U1-U5) of the switching panel may be parallel to a y axis, but not being limited thereto.

FIG. 6 is a top plan view of an alternative exemplary embodiment of the switching panel according to the present invention.

Referring to FIG. 6, the switching panel 409 includes a plurality of unit elements (U1-U6), and the boundaries of the unit elements (U1-U6) are slanted by an angle a with respect to the y axis. In one exemplary embodiment, for example, the angle a may be in a range between about 0 degrees to about 30 degrees.

For convenience of description, an exemplary embodiment in which the boundaries of the unit elements of the switching panel are parallel to the y axis will be described in greater detail.

Referring to FIG. 4, the first electrode layer 190 and the second electrode layer 290 generate the electric field in the liquid crystal layer 3 according to the applied voltage to control the arrangement of the liquid crystal molecules of the liquid crystal layer 3. The alignment layers 11 and 21 determine the initial alignment of the liquid crystal molecules of the liquid crystal layer 3. The liquid crystal layer 3 may be aligned in the electrically controlled birefringence (“ECB”) mode.

The switching panel 400 operates in the 2D mode or the 3D mode according to the voltage applied to the first electrode layer 190 and the second electrode layer 290. When no voltage is applied to the first electrode layer 190 and the second electrode layer 290, the switching panel 400 operates in the 3D mode. This is referred to as a normal 3D mode. When the voltage is applied to the first electrode layer 190 and the second electrode layer 290, the switching panel 400 may operates in the 2D mode. In such an embodiment, an initial alignment direction of liquid crystal molecules 31 and a transmissive axis direction of the polarizer may be appropriately controlled.

When the switching panel 400 operates in the 3D mode, each of the unit elements (U1-U5) of the switching panel 400 functions as a single lens. The liquid crystal molecules 31 are initially aligned such that each of the unit elements (U1-U5) may function as a lens.

An exemplary embodiment, in which the switching panel 400 operates in the 3D mode, that is, an exemplary embodiment, in which no voltage is applied to the first electrode layer 190 and the second electrode layer 290 of the switching panel 400, will now be described.

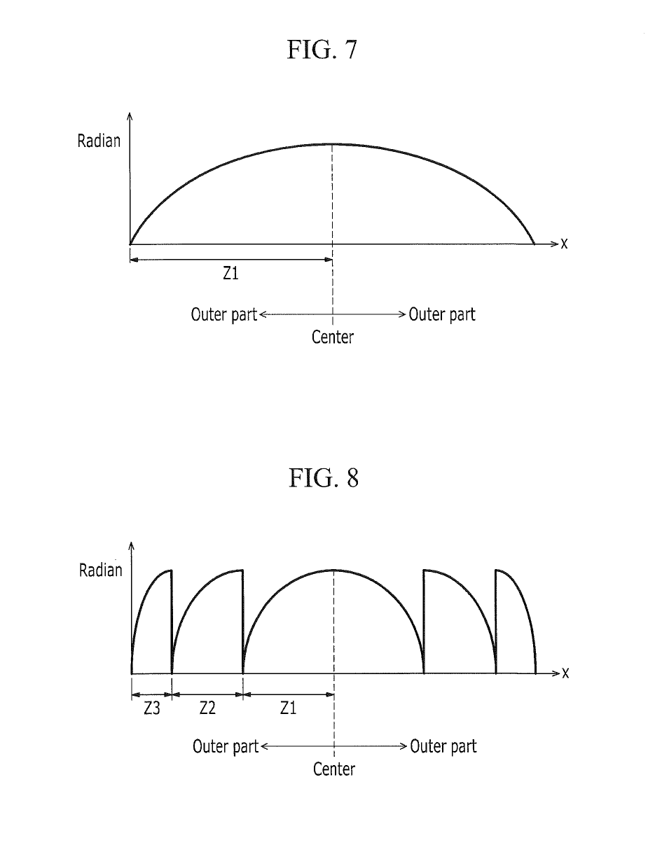

FIG. 7 is a graph showing a phase delay in an exemplary embodiment of a unit element according to positions therein, and FIG. 8 is a graph showing a phase delay in an alternative exemplary embodiment of a unit element according to positions therein. FIG. 7 shows an exemplary embodiment, in which the unit element functions as a gradient-index (“GRIN”) lens, and FIG. 8 shows an exemplary embodiment, in which a unit element functions as a Fresnel zone plate. The Fresnel zone plate generally means a device that functions as a lens using a plurality of concentric circles, and using the diffraction phenomenon of light instead of the refraction phenomenon of light.

Referring to FIGS. 7 and 8, a unit element includes at least one zone sequentially disposed from a center thereof to an outer part thereof. The zones of the unit element of FIGS. 7 and 8 may be substantially symmetric with respect to the center of the unit element. FIG. 7 shows an exemplary embodiment, in which a single zone Z1 is disposed between the center and the outer part of the unit element, and FIG. 8 shows an exemplary embodiment, in which a plurality of zones (Z1-Z3) are disposed between the center and the outer part of the unit element. In FIG. 8, a width of a zone of the zones (Z1-Z3) of the unit element is less than each of widths of other zone of the zones (Z1-Z3) if the zone is disposed closer to the center than the other zone. In an exemplary embodiment, as shown in FIG. 8, a first zone Z1 of the zones disposed closer to the center than a second zone Z2 of the zones, and a width of the first zone Z1 is greater than a width of the second zone Z2. As shown in FIG. 8, an exemplary embodiment of the unit element may include three zones (Z1-Z3) between the center and the outer part, but not being limited thereto.

In FIG. 7, phase delays of the zone Z1 of the unit element increases toward the center of the unit element from the outer part thereof. In FIG. 8, phase delays of the zones (Z1-Z3) of the unit element increase toward the center of the unit element from the outer part of the zone. As shown in FIGS. 7 and 8, in an exemplary embodiment, the phase delays of the unit element may be substantially symmetric with respect to the center of the unit element.

When the phase delay distribution is formed as shown in FIGS. 7 and 8, the unit element may refract the light passing therethrough to be gathered at a focal point by diffraction, destructive interference and constructive interference. Accordingly, the unit element may function as a lens that operates as a GRIN lens or a Fresnel zone plate.

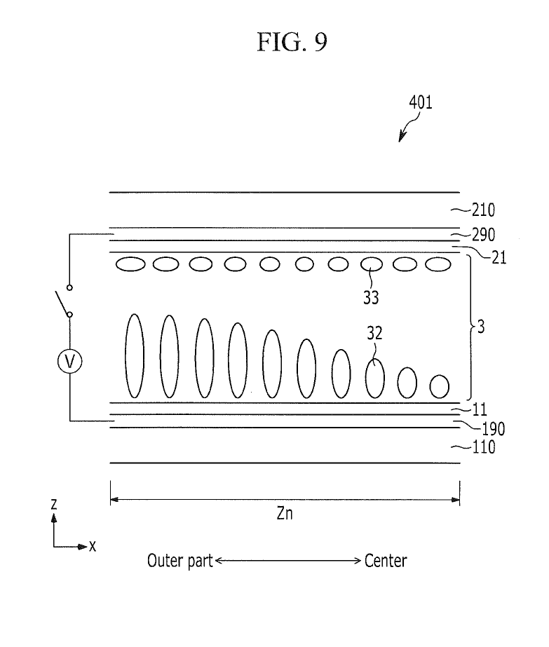

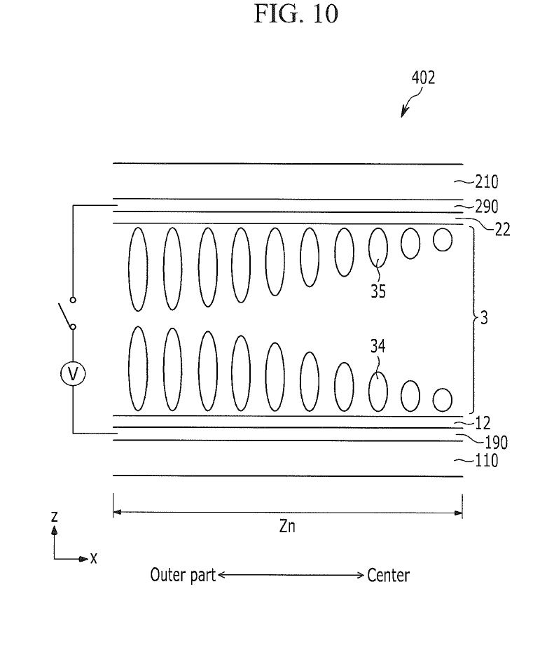

FIG. 9 is a partial cross-sectional view of an exemplary embodiment of a switching panel in a 3D mode according to the present invention. The portion of the switching panel shown in FIG. 9 corresponds to an n-th zone (Zn) of the plurality of zones of the unit element. The n-th zone (Zn) in FIG. 9 may be a zone of the unit element that functions as a GRIN lens or one of a plurality of zones of the unit element that functions as a Fresnel zone plate.

Referring to FIG. 9, no voltage is applied between the first electrode layer 190 and the second electrode layer 290 of the switching panel 401, and the switching panel 401 operates in the 3D mode. A pretilt angle of the liquid crystal molecules 32 near the first alignment layer 11 decreases toward the center of the unit element from the outer part of the n-th zone (Zn). In such an embodiment, the pretilt angle is defined as an angle between the director of the liquid crystal layer 3 and the first substrate 110. The liquid crystal molecules 32 at the outer part of the n-th zone (Zn) are pre-tilted substantially perpendicular to the first substrate 110, and the liquid crystal molecules 32 provided in the center of the n-th zone (Zn) are pre-tilted substantially parallel to the first substrate 110. In such an embodiment, the first alignment layer 11 is optically aligned such that the pretilt angle of the liquid crystal molecules 32 decreases toward the center of the unit element from the outer part of the n-th zone (Zn).

The pretilt angle of the liquid crystal molecules 32 may be in a range from about 90 degrees to about 0 degree toward the center of the unit element from the outer part to the center of the n-th zone (Zn). The minimum pretilt angel may be 1-5 degree in an embodiment, since it is hard to fabricate 0 degree pretilt. In such an embodiment, the pretilt angle of the liquid crystal molecules 32 may change continuously or discontinuously according to the position on the x axis.

Unlike the first alignment layer 11, the second alignment layer 21 of the switching panel 401 is not optically aligned such that the pretilt angle of the liquid crystal layer 3 may not decrease toward the center of the unit element from the outer part of the n-th zone (Zn). Therefore, the liquid crystal molecules 33 near the second alignment layer 21 are not substantially influenced by the first alignment layer 11 and are not pretilted. In such an embodiment, the liquid crystal molecules 33 near the second alignment layer 21 may have a constant pretilt angle with respect to the x axis.

The pretilt angle of the liquid crystal layer 3 on the x axis may be defined by averaging the angle between the director of all the liquid crystal molecules and the first substrate 110. In FIG. 9, the pretilt angle of the liquid crystal layer 3 creases toward the center of the unit element from the outer part of the n-th zone (Zn) because of the liquid crystal molecules 32 near the first alignment layer 11. Therefore, the phase delay in the n-th zone (Zn) increases toward the center of the unit element from the outer part of thereof.

When no voltage is applied between the first electrode layer 190 and the second electrode layer 290, the pretilt angle of the liquid crystal layer 3 may be aligned substantially symmetric with respect to the center of each of the plurality of unit elements of the switching panel 401.

FIG. 10 is a partial cross-sectional view of an alternative exemplary embodiment of a switching panel e in the 3D mode according to the present invention. The switching panel 402 of FIG. 10 is substantially the same as the switching panel 401 of FIG. 9 except for the second alignment layer 22.

Referring to FIG. 10, no voltage is applied between the first electrode layer 190 and the second electrode layer 290 of the switching panel 402, and the switching panel 402 operates in the 3D mode. The pretilt angle of the liquid crystal molecules 34 near the first alignment layer 12 reduced toward the center of the unit element from the outer part of the n-th zone (Zn), and the pretilt angle of the liquid crystal molecules 35 near the second alignment layer 22 decrease toward the center of the unit element from the outer part of the n-th zone (Zn). In such an embodiment, the first alignment layer 12 and the second alignment layer 22 are optically aligned such that the pretilt angles of the liquid crystal molecules 34 and 35 decrease toward the center of the unit element from the outer part of the n-th zone (Zn). Since the pretilt angles of the liquid crystal molecules 34 and 35 decrease toward the center of the unit element from the outer part of the n-th zone (Zn), the pretilt angle of the liquid crystal layer 3 decreases toward the center of the unit element from the outer part of the n-th zone (Zn). Accordingly, the phase delay decreases toward the center of the unit element from the outer part of the n-th zone (Zn).

In an exemplary embodiment, the pretilt angle of the liquid crystal molecules 34 and 35 may be an angle in a range from about 90 degrees to about 0 degree decreasing toward the center of the unit element from the outer part of the n-th zone (Zn). In such an embodiment, the pretilt angles of the liquid crystal molecules 34 and 35 may continuously or discontinuously changes depending on the position of the x axis.

Unlike the exemplary embodiment in FIG. 9, the first alignment layer 12 and the second alignment layer 22 of FIG. 10 may be optically aligned substantially similar to each other.

As shown in FIG. 10, in an exemplary embodiment, in which the first alignment layer 12 and the second alignment layer 22 are optically aligned, the pretilt angles of the liquid crystal molecules 34 and 35 may decrease toward the center of the unit element from the outer part of the zone, phase delay may be less than or equal to about 2 pi radian. In an alternative exemplary embodiment, when the first alignment layer 11 is optically aligned as shown in FIG. 9, a phase delay may be less than or equal to about 1.2 pi radian. Due to the relationship of the phase delay and the gap, a cell gap of the liquid crystal layer 3 of FIG. 10 may be less than a cell gap of the liquid crystal layer 3 of FIG. 9. Accordingly, a cell gap margin of the exemplary embodiment in FIG. 10 may be greater than a cell gap margin of the exemplary embodiment in FIG. 9.

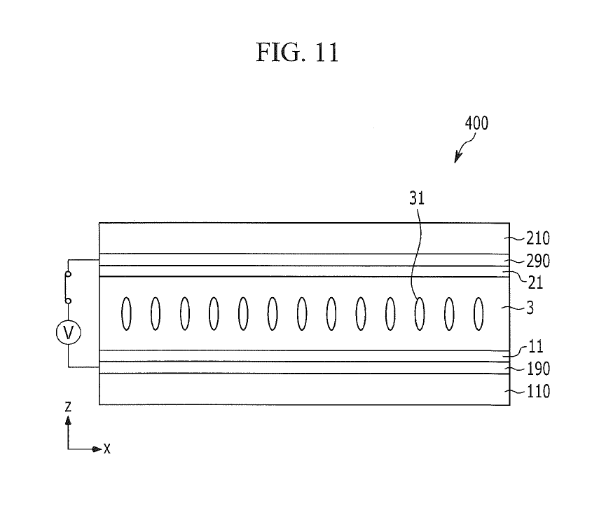

FIG. 11 is a cross-sectional view of an exemplary embodiment of the switching panel in the 2D mode according to the present invention.

Referring to FIG. 11, when the voltage (V) is applied between the first electrode layer 190 and the second electrode layer 290 of the switching panel 400, the switching panel 400 operates in the 2D mode. The liquid crystal molecules 31 in the liquid crystal layer 3 are arranged in the first direction by the voltage difference (V) between the first electrode layer 190 and the second electrode layer 290. In one exemplary embodiment, for example, the first direction may be substantially perpendicular to the first substrate 110. The liquid crystal molecules 31 are arranged in the first direction, such that the phase delays in the switching panel 400 become substantially identical to each other. In such an embodiment, the switching panel 400 generates no phase delay according to the position in 2D mode, and the switching panel 400 does not function as a lens.

In an exemplary embodiment, a voltage greater than a threshold voltage for arranging the liquid crystal molecules 31 in the first direction may be applied between the first electrode layer 190 and the second electrode layer 290 in the 2D mode.

An exemplary embodiment of a method for optically aligning the first alignment layer 11 of the switching panel 400 will now be described. The photo-alignment method will be described with reference to the first alignment layer 11 on the first substrate 110, which may be similarly used for optically aligning the second alignment layer 21 on the second substrate 210.

Before the first substrate 110 and the second substrate 210 are bonded, a photosensitive material is coated on the first electrode layer 190 of the first substrate 110. The photosensitive material may include a polyamic acid or polyimide including a photosensitive group such as cinnamate, chalcone or coumarin, for example. The first alignment layer 11 may be optically aligned by irradiating light such as ultraviolet (“UV”; polarized or not) rays to the photosensitive material. In an exemplary embodiment, an irradiation wavelength of the UV rays may be in a range of about 10 nanometer (nm) and about 400 nanometer (nm). In an alternative exemplary embodiment, an irradiation wavelength of the UV rays may be in a range between about 280 nm and about 340 nm. Light irradiation energy may be in a range from about 1 milijoule (mJ) to about 5,000 milijoules (mJ). However, the light irradiation energy and the irradiation wavelength are not limited thereto. In an alternative exemplary embodiment, the light irradiation energy and the irradiation wavelength may vary depending on a material of the first alignment layer 11.

The first alignment layer 11 may be optically aligned by controlling light irradiated to the zone of the unit element. The pretilt angle of the liquid crystal layer 3 may increase or decrease as the amount of irradiated light is increased or decreased. The amount of irradiated light may be determined by the material of the first alignment layer 11. Therefore, the first alignment layer 11 may be optically aligned by increasing or decreasing the amount of light irradiated to the alignment layer from the outer part to the center of the zone according to the material of the first alignment layer 11 toward the center of the unit element from the outer part of the zone. For convenience of description, an exemplary embodiment, in which the pretilt angles of the liquid crystal molecules are decreased as the amount of irradiated light is increased.

According to FIG. 11, the liquid crystal layer 3 is aligned in vertical direction under applied voltage, since positive liquid crystal is used. In a different embodiment, a negative liquid crystal also can be used as the liquid crystal layer 3, and then the liquid crystal layer 3 is aligned in horizontal direction under applied voltage.

The first alignment layer 11 may be optically aligned using a mask.

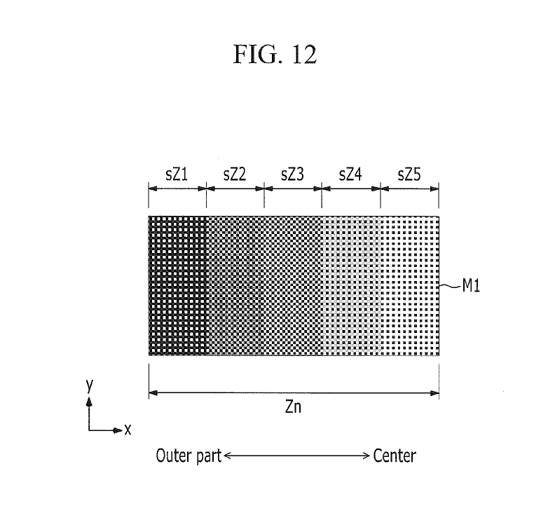

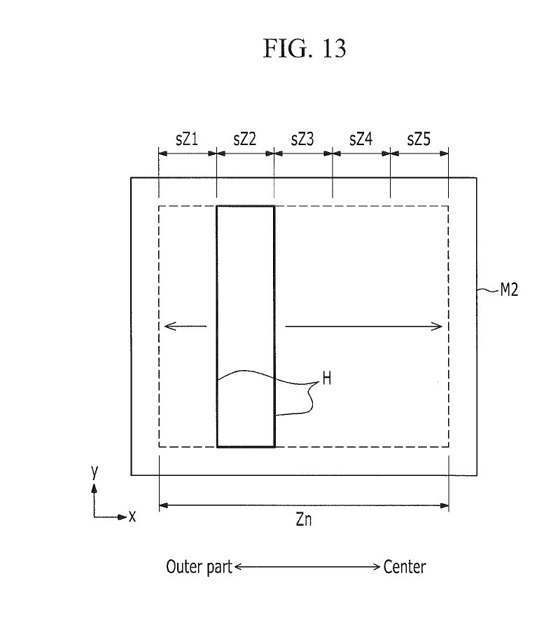

FIG. 12 is a top plan view of an exemplary embodiment of a mask for photo-alignment of an alignment layer, and FIG. 13 is a top plan view of an alternative exemplary embodiment of the mask for photo-alignment of an alignment layer. In FIGS. 12 and 13, the mask is arranged with the n-th zone (Zn) of the unit element.

Referring to FIG. 12, the mask M1 corresponding to the n-th zone (Zn) includes a plurality of subzones sZ1, sZ2, sZ3, sZ4 and sZ5. In an exemplary embodiment, as shown in FIG. 12, the mask M1 may be a gray-tone mask having different transmittance for each of the subzones sZ1, sZ2, sZ3, sZ4 and sZ5. The subzones from the outer part to the center are sequentially indicated as sZ1, sZ2, sZ3, sZ4 and sZ5. A width of each of the subzones sZ1, sZ2, sZ3, sZ4 and sZ5 of the mask M1 may be greater than about 50 nm. Transmittance of the mask M1 is increased from the subzone sZ1 in the outer part to the subzone sZ5 in the center of the mask M1. Therefore, the amount of light irradiated to the alignment layer is increased toward the center of the unit element from the outer part of the n-th zone (Zn), the pretilt angle of the liquid crystal molecules decreases toward the center of the unit element from the outer part of the n-th zone (Zn), and the phase delay is thereby increased toward the center of the unit element from the outer part of the n-th zone (Zn).

In an exemplary embodiment, when the mask M1 includes a plurality of discontinuous subzones sZ1, sZ2, sZ3, sZ4 and sZ5, the amount of light irradiated to the boundaries of the subzones sZ1, sZ2, sZ3, sZ4 and sZ5 may be continuously changed because a subzone may be influenced by the light irradiated to an adjacent subzone.

FIG. 12 shows that the mask M1 includes a plurality of discontinuous subzones sZ1, sZ2, sZ3, sZ4, and sZ5, and transmittance of the mask M1 may be increased toward the center of the unit element from the outer part of the zone. In one exemplary embodiment, for example, transmittance of the mask M1 at the outermost part of the n-th zone (Zn) has 0% transmittance and transmittance of the mask M1 at the center of the n-th zone (Zn) has 100% transmittance, and the transmittance may be substantially continuously increased toward the center of the unit element from the outer part.

Therefore, the amount of light irradiated to zones of the unit element may be substantially continuously changed. When transmittance of the mask M1 is continuously increased, the pretilt angle of the liquid crystal molecules may be continuously decreased and the phase delay may be continuously increased, thereby improving the lens characteristic of the switching panel.

Referring to FIG. 13, the mask M2 corresponding to the n-th zone (Zn) may be a slit mask including an opening (H) that shifts along the x axis direction. The opening (H) of the mask M2 may be shifted to the subzones sZ1, sZ2, sZ3 and sZ4. In an exemplary embodiment the opening (H) of the mask M2 is shifted from the outer part of the n-th zone (Zn) to the center. The amount of light irradiated to the alignment layer may be controlled by controlling duration of irradiating light depending on the position of the opening (H) in the mask M2. That is, the duration of irradiating light to the alignment layer may be increased as the opening (H) moves toward the subzone sZ5 in the center from the subzone sZ1 at the outer part. Therefore, the amount of light irradiated to the alignment layer is increased toward the center of the unit element from the outer part of the n-th zone (Zn), the pretilt angle of the liquid crystal molecules is decreased toward the center of the unit element from the outer part of the n-th zone (Zn), and the phase delay is thereby increased toward the center of the unit element from the outer part of the n-th zone (Zn).

In an alternative exemplary embodiment, the photo-alignment process may be simplified with the slit mask M2 including the opening (H) that shifts, as shown in FIG. 13. In such an embodiment, the amount of light irradiated to the zone of the unit element may be changed substantially discontinuously. Therefore, the pretilt angle of the liquid crystal layer may be discontinuously decreased toward the center of the unit element from the outer part of the zone when the exemplary embodiment of the mask M2 shown in FIG. 13 is used.

Accordingly, the switching panel may include a plurality of domains with different alignment directions of the liquid crystal molecules in a single zone of the unit element using the optically aligned alignment layer.

Therefore, the image display device for improving the lens characteristic is provided.

In a switching panel using a voltage applying method, in which a voltage is applied in the 3D mode by generating an electric field in the liquid crystal layer 3 such that the liquid crystal molecules are aligned to function as a lens, a microelectrode pattern may be disposed in the first electrode layer 190 in the unit element. When the microelectrode patter is disposed in the first electrode layer, the size of the microelectrode pattern may be greater than or equal to the cell gap. The phase delay may be ineffectively controlled because of limitations in the process for forming the minute electrode pattern and the cell gap. Also, a short circuit may occur between the microelectrodes. When the first electrode layer 190 has a multi-layer electrode structure, an erroneous arrangement of the electrodes may occur.

In an exemplary embodiment of the present invention, the first electrode layer 190 includes a continuously formed single electrode without the microelectrode pattern. In such an embodiment, the cell gap margin is obtained, the process is simplified the short circuit between the microelectrodes and the erroneous arrangement of the multi-layer electrode structure between the electrodes are effectively prevented. In an exemplary embodiment, the first electrode layer 190 may have a planarized surface to effectively control the liquid crystal molecules.

In an exemplary embodiment, a more precise phase delay profile may be realized, that is, phase delay with more levels compared to the voltage applying method may be realized. In contrast to the voltage applying method, in which the phase delay distribution may be discontinuous, phase delay distribution may be continuous in an exemplary embodiment of the present invention.

In the voltage applying method, in which a fringe field may be formed when different voltages are applied between opposing electrodes in the switching panel, the liquid crystal aligned in the ECB mode may be rotated in the horizontal direction, and thus an incomplete liquid crystal arrangement may occur. In the voltage applying method, the polarization axis of the incident light may be shifted, and optical efficiency may be thereby deteriorated.

According to an exemplary embodiment of the present invention, the 3D mode is operated without applying a voltage between the opposing electrodes in the switching panel, such that the lens efficiency of the switching panel is substantially improved by effectively preventing the optical efficiency deterioration due to the fringe field.

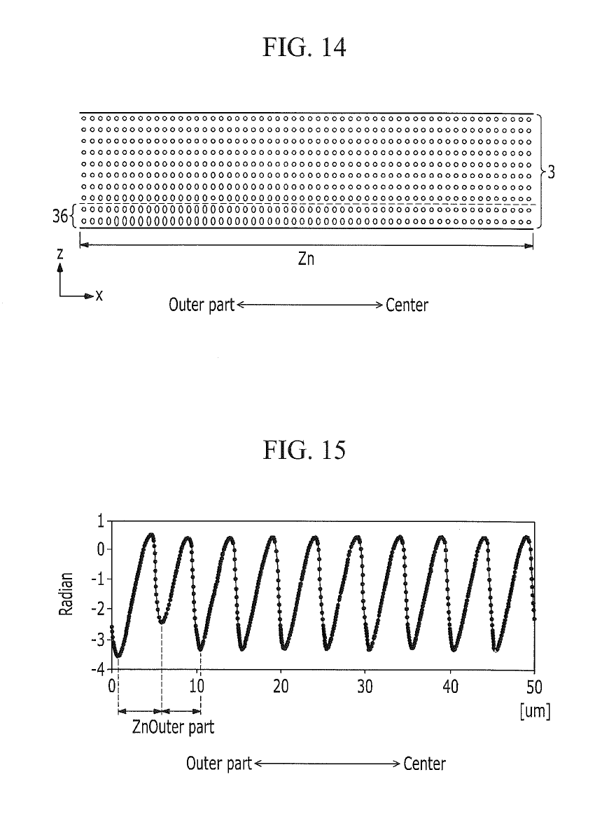

FIG. 14 is a plan view showing an arrangement of liquid crystal molecules in a liquid crystal layer of an exemplary embodiment of the switching panel in the 3D mode according to the present invention. In FIG. 14, the switching panel corresponds to the n-th zone (Zn), which is a zone of the unit element.

Referring to FIG. 14, in an exemplary embodiment, the pretilt angle of the liquid crystal molecules 36 near the alignment layer of the lower substrate decreases toward the center of the unit element from the outer part of the n-th zone (Zn). In such an embodiment, the liquid crystal molecules 36 at the outermost part of the n-th zone (Zn) are pretilted along a direction substantially parallel to the lower substrate because they are influenced by an adjacent zone near the outer part of the n-th zone (Zn). However, the pretilt angle of the liquid crystal molecules 36 generally decrease toward the center of the unit element from the outer part of the n-th zone (Zn) such the switching panel operates in the 3D mode without applying a voltage between the opposing electrodes.

FIG. 15 is a graph showing a phase delay according to a position on an exemplary embodiment of the switching panel in the 3D mode according to the present invention.

Referring to FIG. 15, the phase delay increases toward the center of the unit element from the outer part of each zone. In one exemplary embodiment, for example, the width of the zone is about 5 micrometer (um). In an alternative exemplary embodiment, the width of the zone may be less than 5 um using a gray tone mask having a width of 50 nm. In such an embodiment, the boundary between the unit elements and the boundary between the zones in the unit element may be substantially accurate formed without including a microelectrode pattern in the first electrode layer 190 on the first substrate 110. Therefore, performance of the lens is substantially improved.

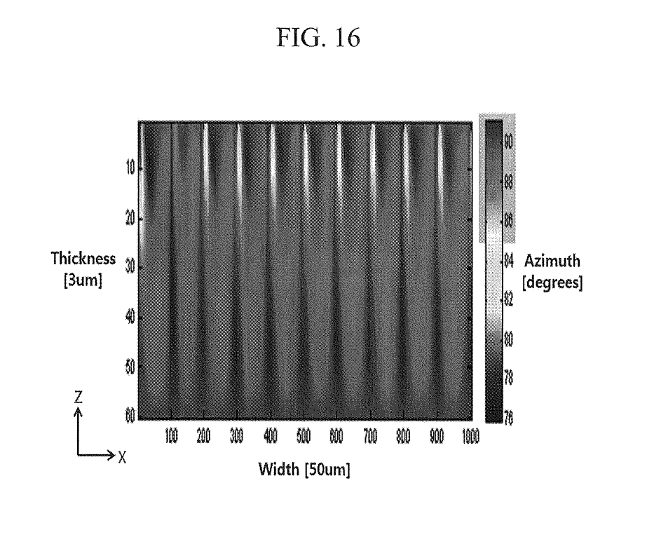

FIG. 16 is a graph showing an azimuth according to a position in an exemplary embodiment of the switching panel in the 3D mode according to the present invention.

FIG. 16 illustrates the azimuth by dividing the width of 50 um in the x-axis direction on the x-z plane of the switching panel of FIG. 4 by 1000, and by dividing the thickness of 3 um in the z-axis direction by 60. The azimuth represents an amount of which the director of the liquid crystal molecules is digressed from the x axis in angular degree. In an exemplary embodiment, the azimuth may be maintained to have a degree substantially close to 90 degrees. Regarding FIG. 16, the distribution of the azimuth may be substantially near 90 degrees. In an exemplary embodiment, the azimuth may be in a range between about 86 degrees and about 90 degrees. In the voltage applying method, the azimuth is digressed by an angle in a range between +90 to −90 degrees because of the fringe field. Therefore, according to the exemplary embodiments of the present invention including switching panel having a characteristic of a lens in 3D mode while no voltage is applied, distortion of the polarization axis caused by the fringe field is substantially reduced or effective prevented, and optical efficiency is thereby improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An image display device comprising
a display panel which displays an image, and
a switching panel which operates in at least one of a two-dimensional mode and a three-dimensional mode, wherein the switching panel controls the image of the display panel to be recognized as a two-dimensional image in the two-dimensional mode and as a three-dimensional image in the three-dimensional mode,
wherein the switching panel comprises:
a first substrate;
a second substrate disposed opposite to the first substrate;
a first electrode layer disposed on the first substrate;
a first alignment layer disposed on the first electrode layer;
a second electrode layer disposed on the second substrate; and
a liquid crystal layer disposed between the first substrate and the second substrate,
wherein the switching panel includes a plurality of unit elements, and
wherein when no voltage is applied between the first electrode layer and the second electrode layer, a pretilt angle of the liquid crystal layer is repeated in the plurality of unit elements.

2. The image display device of claim 1, wherein
a first unit element of the plurality of unit elements includes at least one zone, and
the first alignment layer is optically aligned such that the pretilt angle of the liquid crystal layer corresponding to the first unit element decreases toward a center of the first unit element from an outer part of the at least one zone.

3. The image display device of claim 2, wherein
when no voltage is applied between the first electrode layer and the second electrode layer, the switching panel operates in the 3D mode, and
when a voltage is applied between the first electrode layer and the second electrode layer, the switching panel operates in the two-dimensional mode.

4. The image display device of claim 3, wherein,
the at least one zone of the first unit element is disposed substantially symmetric with respect to the center of the first unit element.

5. The image display device of claim 4, wherein
when the switching panel operates in the three-dimensional mode, the pretilt angle of the liquid crystal layer corresponding to the first unit element is substantially symmetric with respect to the center of the first unit element.

6. The image display device of claim 3, wherein
when the switching panel operates in the two-dimensional mode, the liquid crystal layer is vertically aligned.

7. The image display device of claim 6, wherein
when the switching panel operates in the two-dimensional mode, the switching panel has a same phase delay in each position thereon.

8. The image display device of claim 7, wherein
when the switching panel operates in the three-dimensional mode, the phase delay increases toward the center of the first unit element from the outer part of the at least one zone.

9. The image display device of claim 2, wherein
the pretilt angle of the liquid crystal layer corresponding to the first unit element decreases toward the center of the first unit element from the outer part of the at least one zone,
the pretilt angle of the liquid crystal layer at the center of the first unit element is about zero degree, and
the pretilt angle of the liquid crystal layer at the outer part of the at least one zone is about 90 degrees.

10. The image display device of claim 9, wherein
the pretilt angle of the liquid crystal layer corresponding to the first unit element continuously decreases toward the center of the first unit element from the outer part of the at least one zone.

11. The image display device of claim 9, wherein
the pretilt angle of the liquid crystal layer corresponding to the first unit element discontinuously decreases toward the center of the first unit element from the outer part of the at least one zone.

12. The image display device of claim 2, further including
a second alignment layer disposed on the second electrode layer.

13. The image display device of claim 12, wherein
the pretilt angle of the liquid crystal layer near the second alignment layer is substantially constant.

14. The image display device of claim 12, wherein
the second alignment layer is optically aligned such that the pretilt angle of the liquid crystal layer corresponding to the first unit element decreases toward the center of the first unit element from the outer part of the at least one zone.

15. The image display device of claim 2, wherein
the first unit element includes a plurality of zones sequentially disposed from the center thereof such that a first zone thereof is disposed closer to the center thereof than a second zone thereof, and
a width of the first zone is greater than a width of the second zone.

16. The image display device of claim 15, wherein
when the switching panel operates in the three-dimensional mode, the first unit element operates as a Fresnel zone plate.

17. A method for manufacturing a switching panel including a first substrate, a second substrate disposed opposite to the first substrate, a first electrode layer disposed on the first substrate, a second electrode layer disposed on the second substrate, and a liquid crystal layer disposed between the first substrate and the second substrate, the method comprising:
coating a photosensitive material on the first electrode layer disposed on the first substrate; and
irradiating light to the photosensitive material,
wherein the switching panel includes a plurality of unit elements,
wherein a first unit element of the plurality of unit elements includes at least one zone sequentially disposed with respect to a center of the first unit element, and
wherein the irradiating of light to the photosensitive material comprises irradiating light with at least one of increased intensity and decreased intensity toward the center of the first unit element from an outer part of the at least one zone.

18. The method of claim 17, further comprising
arranging the at least one zone and a mask, wherein
transmittance of the mask decreases or increases toward the center of the first unit element from the outer part of the at least one zone.

19. The method of claim 18, wherein
the mask includes a plurality of subzones sequentially disposed toward the center of the first unit element from the outer part of the at least one zone, and
a transmittance of the plurality of subzones decreases or increases toward the center of the first unit element from the outer part of the at least one zone.

20. The method of claim 17, further comprising
arranging the at least one zone and a mask,
wherein the mask includes an opening which shifts, and a duration of light irradiation to the at least one zone is controlled by shifting the opening.
